(19) United States
(12) Patent Application Publication
(10) Pub. No.: US 2010/0219712 A1
(43) Pub. Date: Sep. 2, 2010

(54) ROTOR OF ROTARY ELECTRIC MACHINE, AND PRODUCTION METHOD THEREFOR

(75) Inventors: Tomonari Kogure, Aichin-ken (JP); Keiu Kanada, Aichin-ken (JP); Masaaki Hiraga, Aichin-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, AICHI-KEN (JP)

(21) Appl. No.: 12/599,538

(22) PCT Filed: May 9, 2008
(86) PCT No.: PCT/IB08/01160

§ 371 Date: Nov. 10, 2009

(30) Foreign Application Priority Data
May 11, 2007 (JP) 2007-127044

(51) Int. Cl. H02K 1/27; H01F 41/02

(52) U.S. Cl. 310/156.43; 29/598

(57) ABSTRACT

A rotor (104) includes a rotor core (105) and permanent magnets (111, 112, 121, 122) embedded in the rotor core (105). The permanent magnet (111) includes a first surface that is a flat surface facing a stator side, and a second surface that is opposite from the first surface. A center position of a middle portion of the permanent magnet (111) which is a center in the magnetization direction of the permanent magnet (111) is positioned in a stator side of a center position of two opposite end portions of the permanent magnet (111) in a direction orthogonal to the magnetization direction which is a center in the magnetization direction.

### BACKGROUND OF THE INVENTION

1. Field of the Invention

The invention relates to a rotor of a rotary electric machine and a production method for the rotor. More particularly, the invention relates to an embedded permanent magnet-type rotor and a production method for therefor.

2. Description of the Related Art

A rotary electric machine having an embedded permanent magnet-type rotor is a high-output motor that utilizes magnet torque and reluctance torque. In recent years, rotary electric machines having embedded permanent magnet-type rotors have come to be used in the driving devices for vehicles, for example, electric motor vehicles, hybrid motor vehicles, etc.

Japanese Patent Application Publication No. 2006-166625 (JP-A-2006-166625) describes a rotary electric machine that is able to increase the rotator torque by reducing the magnetic resistance.

This rotary electric machine has a rotator in which magnets are attached to a rotator iron core whose two opposite end surfaces are penetrated by a rotating shaft, and a stator in which stator winding wire is wound on a stator iron core that embraces the rotator. The rotator and the stator are rotatably retained with an air gap left between the rotator and the stator. The rotator is provided with magnet-fitting gaps which are open in two opposite end surfaces and into which magnets are inserted so that salient poles are formed between the poles of magnets. For example, as for the configuration of the magnets of this type of rotary electric machine, some employ magnets having a shape in which a middle portion of the magnet is recessed from an outer peripheral side.

FIG. 12 is a diagram for describing demagnetization of the magnets of an embedded permanent magnet-type rotor. Referring to FIG. 12, the rotor includes a rotor core 502, and permanent magnets 504 inserted in holes that are formed in the rotor core 502. In the portion shown in FIG. 12, the permanent magnet 504 is disposed so that its N-pole is at an outer peripheral side with respect to the rotor, and its S-pole is at the inner peripheral side.

A stator coil 506 is disposed facing the outer periphery of the rotor. By the stator coil 506, a rotating magnetic field is produced, so that the rotor rotates. An alternating current is caused to flow through the stator coil 506 in order to produce the rotating magnetic field.

In one case during the production of the rotating magnetic field, the end of the stator coil 506 closer to the rotor becomes the N-pole as shown in FIG. 12. In this case, the stator coil 506 gives to the permanent magnet 504 a reverse magnetic field that repels the magnetic field of the permanent magnet 504. Therefore, demagnetization occurs in two opposite end portions X1, X2 of the permanent magnet 504 in a direction orthogonal to the magnetization direction thereof. The magnetic field from the stator coil tends to concentrate at the rotor outer periphery-side two opposite ends of the magnet, so that the two opposite end portions of the magnet are more likely to undergo irreversible demagnetization than the other portions of the magnet.

In order to achieve an improved demagnetization resistance of a magnet, it is effective to increase the thickness of the magnet, or to use a magnet that contains a rare earth that improves the demagnetization resistance. However, either measure markedly increases the cost. Besides, in respect of decreasing the usage of magnets, it is also conceivable to increase the thickness of the magnets only at the two opposite ends. However, if a magnet configuration of the magnet embedded-type rotor in which a middle portion in the rotating direction is recessed from the outer periphery-side portions is adopted as described in Japanese Patent Application Publication No. 2006-166625 (JP-A-2006-166625), the increased distance between the middle portion and the stator will decrease the torque that can be produced.

### SUMMARY OF THE INVENTION

The invention provides a rotor of a rotary electric machine that is improved in demagnetization resistance while cost increase is restrained.

A first aspect of the invention relates to a rotor for a rotary electric machine that turns about a rotation axis of the rotary electric machine, the rotor having a rotor core and a permanent magnet embedded in the rotor core. In this rotor for a rotary electric machine, the permanent magnet includes a first surface facing a side of a stator of the rotary electric machine, and a second surface opposite from the first surface, and a center position of a middle portion of the permanent magnet, in a magnetization direction of the permanent magnet is closer to the stator than a center position in the magnetization direction of two opposite end portions of the permanent magnet which are arranged in a direction orthogonal to the magnetization direction is to the stator.

In this construction, a section of the permanent magnet orthogonal to the rotation axis may be generally a rectangle in shape, and the second surface may have, in a middle portion thereof, a recess portion.

In the foregoing construction, in a section of the permanent magnet orthogonal to the rotation axis, the permanent magnet may have a first magnet piece and a second magnet piece that are arranged so that the magnetization direction of the first magnet piece and the magnetization direction of the second magnet piece align and so that the first and second magnet pieces are juxtaposed in a direction orthogonal to the magnetization direction, and a third magnet piece that is arranged so that the third magnet piece is positioned between the first and second magnet pieces and so that the magnetization direction of the third magnet piece aligns with the magnetization direction of the first and second magnet pieces, and a thickness of each of the first and second magnet pieces in the magnetization direction may be greater than a thickness of the third magnet piece in the magnetization direction.

In the foregoing construction, each of the first to third magnet pieces may be rectangular in the section.

In the foregoing construction, the stator may be arranged radially outward of the rotor, and the rotor may further include a plurality of permanent magnets that have the same configuration as the permanent magnet, and the plurality of permanent magnets may be divided into a plurality of pairs, and the permanent magnets of each pair may be arranged in a V-shape so that each of adjacent portions of the paired permanent magnet is positioned closer to the rotation axis than two end portions of the paired permanent magnet.

A second aspect of the invention relates to a production method for a rotor for a rotary electric machine. The production method for a rotor for a rotary electric machine includes: inserting a first magnet piece whose sectional shape is generally rectangular into each of a plurality of holes formed in a rotor core; inserting, into the each of the plurality of holes, a second magnet piece whose sectional shape is generally rectangular to a position apart from the first magnet piece which is in each of the plurality of holes; and inserting a third magnet piece whose sectional shape is generally rectangular between the first and second magnet pieces in each of the plurality of holes.

This production method may further include pouring a resin for fixing the first to third magnet pieces into each of the plurality of holes.

In the foregoing method, the first to third magnet pieces may be arranged so that magnetization directions of the first to third magnet pieces align and so that the first to third magnet pieces are juxtaposed in a direction orthogonal to the magnetization direction, and the first and second magnet pieces may be arranged so that a center position of the first and second magnet pieces in the magnetization direction is more remote from a stator arranged radially outward of the rotor than a center position of the third magnet piece in the magnetization direction is from the stator.

According to the invention, a rotor for a rotary electric machine whose demagnetization resistance is improved can be realized with a low cost.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a sectional view for describing the positions of a rotor and a stator of an electric motor in accordance with an embodiment of the invention;

FIG. 2 is an enlarged sectional view showing permanent magnets of the rotor shown in FIG. 1 and their vicinities;

FIG. 3 is a perspective view for describing the configuration of a magnet in a state in which the magnet is inserted in the rotor shown in FIG. 2;

FIG. 4 is a flowchart showing a production method for a rotor of a motor in accordance with an embodiment of the invention;

FIG. 5 is a diagram showing a first modification of the magnet configuration shown in FIG. 2;

FIG. 6 is a diagram showing a second modification of the magnet configuration shown in FIG. 2;

FIG. 7 shows an example in which a magnet is not divided but is integrally formed in a cross section as shown in FIG. 2;

FIG. 8 is a perspective view showing the magnet configuration shown in FIG. 7;

FIG. 9 shows an example in which a magnet is divided in a modified method in a cross-section as shown in FIG. 2;

FIG. 10 is a perspective view showing the magnet configuration shown in FIG. 9;

FIG. 11 is a diagram showing an example of the magnet arrangement that is not a V-shape arrangement; and

FIG. 12 is a diagram for describing the demagnetization of the magnets of an embedded permanent magnet-type rotor.

### DETAILED DESCRIPTION OF EMBODIMENTS

Hereinafter, embodiments of the invention will be described in detail with reference to the drawings. The same or corresponding portions are assigned with the same reference characters in the drawings, and the description thereof will not be repeated.

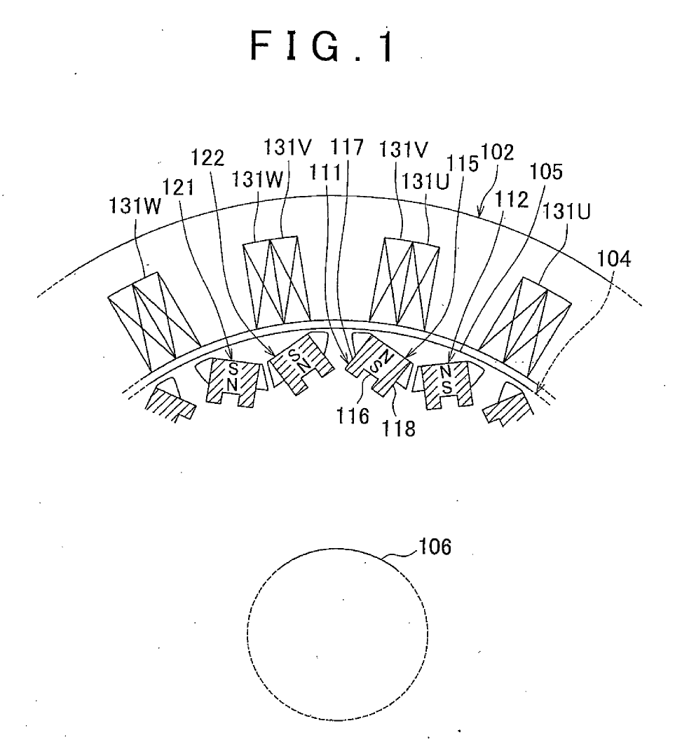

FIG. 1 is a sectional view for describing the positions of a rotor and a stator of an electric motor in accordance with an embodiment of the invention.

Referring to FIG. 1, a motor that is a rotary electric machine includes a stator 102 and a rotor 104. The rotor 104 includes a shaft 106, and a rotor core 105 that is provided around the shaft 106. FIG. 1 shows in detail portions of the rotor and the stator corresponding to one sixth of the whole circumference thereof.

The rotor core 105 is formed by, for example, stacked electromagnetic steel sheets. The rotor 104 in FIG. 1 has 12 poles. For each pole, a pair of magnets arranged in a V-shape is used. The rotor core 105 is provided with 24 holes for inserting magnets. In such holes, magnets 111, 112, 121, 122 are inserted.

The stator 102 includes a stator core, and coils 131U, 131V, 131W wound on the teeth of the stator core. The U-phase current, the V-phase current, and the W-phase current are caused to flow through the coils 131U, 131V, 131W, respectively, from an inverter unit (not shown).

The rotor 104 shown in FIG. 1 is a rotor of a rotary electric machine which is provided around the rotating shaft 106 of the rotary electric machine. The rotor 104 is provided with a rotor core 105, and permanent magnets 111, 112, 121, 122 embedded in the rotor core. The permanent magnet 111 includes a first surface 115 that is a flat surface that faces the stator side, and a second surface 116 that is a surface opposite from the first surface 115. The second surface 116 has, in a section thereof orthogonal to the rotating shaft 106, that is, a cross section shown in FIG. 1, a configuration in which the thickness of the permanent magnet 111 in the magnetization direction of the permanent magnet (the direction from the N-pole toward the S-pole) is greater at two opposite ends thereof in the direction orthogonal to the magnetization direction than at a middle portion between the two opposite ends.

The cross section of the permanent magnet orthogonal to the rotating shaft 106 is generally rectangular. Of the four sides of the rectangular shape, a side contained in the second surface 116 has, in a middle portion thereof, a recess. The rectangular shape may be a rectangle or may also be a square. As for the four sides of the rectangle, at least one or all of the sides contained in the surfaces 115, 117, 118 may be provided with a recess that is smaller than the recess of the side contained in the surface 116.

The rotary electric machine may also be of an outer rotor type. Preferably, however, the stator 102 is disposed radially outward of the rotor 104. The rotor 104 of the rotary electric machine is provided further with a plurality of permanent magnets 112, 121, 122 that have the same configuration as the permanent magnet 111. The permanent magnet 111 and the plurality of other permanent magnets 112, 121, 122 are divided into a plurality of pairs. The permanent magnets 111, 112 that make a pair are arranged in such a V-shape that portions of the magnets adjacent to each other are relatively close to the rotating shaft. The permanent magnets 121, 122 that make a pair are arranged in such a V-shape that portions of the magnets adjacent to each other are relatively close to the rotating shaft. Arranging the magnets in a V-shape improves the reluctance torque.

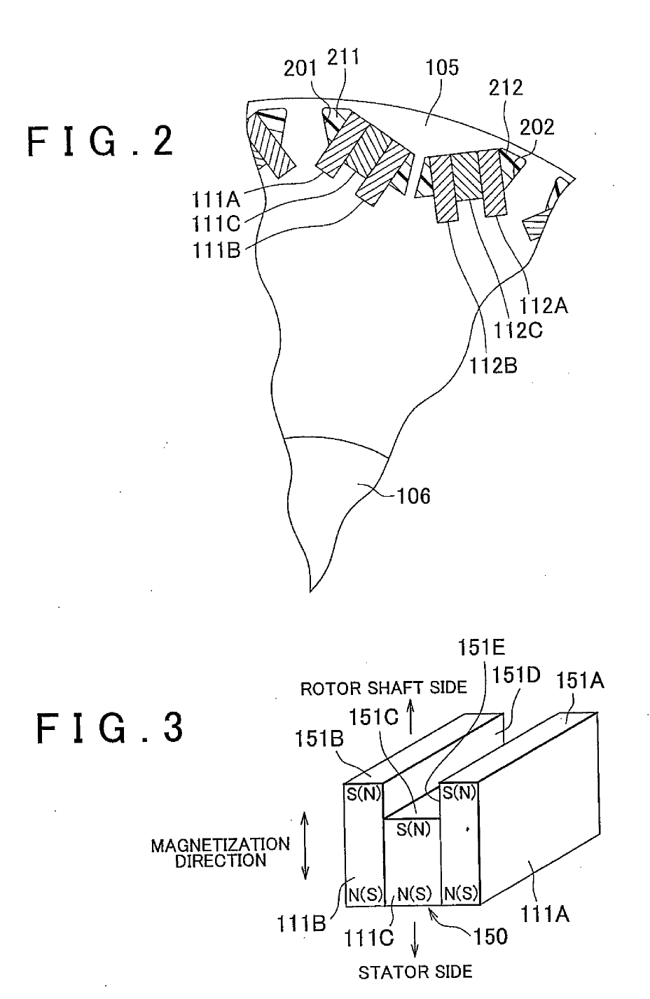

FIG. 2 is an enlarged sectional view of permanent magnets of the rotor and a portion of the rotor adjacent to the permanent magnets. Referring to FIG. 2, the rotor core 105 is disposed around the rotating shaft 106. The rotor core 105 is provided with holes 201, 202 for inserting magnets.

The permanent magnet 111 includes magnet pieces 111A, 111B, 111C. Before or after the magnet pieces 111A to 111C are inserted into the hole 201, a resin 211 for fixing the magnet pieces 111A to 111C is poured into the hole 201.

The permanent magnet 112 includes magnet pieces 112A, 112B, 112C. Before or after the magnet piece 112A to 112C are inserted into the hole 202, a resin 212 for fixing the magnet piece 112A to 112C is poured into the hole 202.

FIG. 3 is a perspective view for describing the configuration of a magnet in a state where the magnet is inserted in the rotor. In FIG. 3, the rotor core is not shown, but only a magnet is shown.

Referring to FIGS. 2 and 3, the permanent magnet 111 has the first magnet piece 111A and the second magnet piece 111B that are arranged in the cross-section so that their magnetization directions align and so that they are juxtaposed in the direction orthogonal to the magnetization direction, and the third magnet piece 111C that is arranged in the cross-section so that the third magnet piece 111C is positioned between the first magnet piece 111A and the second magnet piece 111B, and so that the magnetization direction of the third magnet piece 111C aligns with the magnetization direction of the first magnet piece 111A and the second magnet piece 111B. The thickness of the first magnet piece 111A and the second magnet piece 111B in the magnetization direction is greater than the thickness of the third magnet piece 111C in the magnetization direction.

The magnet pieces 111A, 111B, 111C are arranged so that the stator-side surfaces thereof form a generally flush flat surface 150 and so that, on the rotor shaft side, a stepped surface is formed in which a surface 151C of the magnet piece 11C is recessed from surfaces 151A, 151B of the magnets 111A, 111B. Incidentally, surfaces 151D, 151E of the magnet pieces 111B, 111A are step height surfaces on the rotor shaft side.

The magnet pieces 111A, 111B, 111C of the rotor in this embodiment are arranged so that their magnetization directions are aligned so that all the three magnet pieces have their N-poles on the stator side, and their S-poles on the rotor shaft side. Alternatively, conversely, the magnet pieces are arranged so that their magnetization directions are aligned so that their S-poles are on the stator side and their N-poles are on the rotor shaft side.

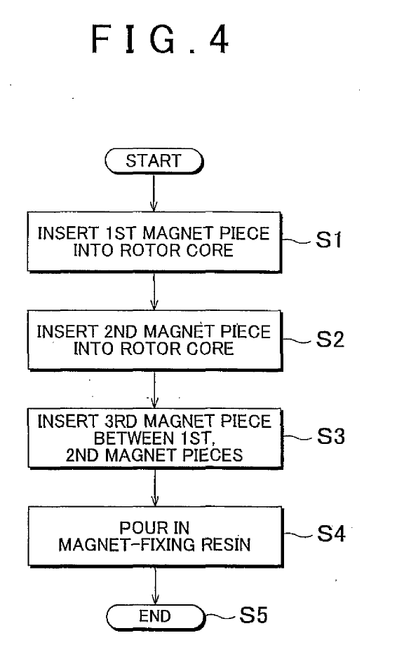

FIG. 4 is a flowchart showing processes of a production method for the rotor. Referring to FIGS. 2 and 4, firstly, a rotor core 105 in which electromagnetic steel sheets are stacked is prepared, and in step S1, the first magnet pieces 111A, 112A are inserted into the rotor core 105.

Subsequently in step S2, the second magnet pieces 111B, 112B are inserted into the rotor core 105.

Then in step S3, the third magnet piece 111C is inserted between the first magnet piece 111A and the second magnet piece 111B that have already been inserted, and the third magnet piece 112C is inserted between the first magnet piece 112A and the second magnet piece 112B that have already been inserted.

Since the rotor shaft side of each of the holes 201, 202 is provided with a stepped configuration that corresponds to the step height surfaces 151D, 151E shown in FIG. 3, the positions of insertion of the magnet pieces 111A, 111B are determined. If it is attempted to firstly insert the magnet piece 111C, the position of insertion thereof is not determined. However, after the magnet pieces 111A, 111B have been disposed on the two opposite sides, the position of insertion of the magnet piece 111C is readily determined.

Thus, inserting the magnet pieces in this sequence makes it possible to efficiently perform the assembly operation. Incidentally, the sequence of step S1 and step S2 may also be reversed, and will achieve substantially the same effect.

After the insertion of the magnet piece in step S3 is completed, the pouring in of a magnet-fixing resin is performed in step S4. This prevents the wobbling or falling-apart of the magnet pieces. Incidentally, the resin may also be poured in an amount that corresponds to the space between the magnets and the rotor core before the magnets are inserted.

After the processes of step S1 to S4 end, the assembly of the rotor comes to an end in step S5. From the foregoing description, the production method for a rotor for a rotary electric machine in accordance with another aspect of the invention will be summarized. The production method for a rotor for a rotary electric machine includes the step S1 of inserting first magnet pieces 111A, 112A whose sectional shape is generally rectangular into a plurality of holes 201, 202, respectively, that are formed in the rotor core 105, the step S2 of inserting second magnet pieces 111B, 112B whose sectional shape is generally rectangular to positions apart from the first magnet pieces 111A, 112A in the holes 201, 202, respectively, and the step S3 of inserting third magnet pieces 111C, 112C whose sectional shape is generally rectangular between the first and second magnet pieces in the holes 201, 202, respectively.

The production method for the rotor for a rotary electric machine may further include the step S4 of pouring resin 211, 212 for fixing the first to third magnet pieces into the holes 201, 202, respectively.

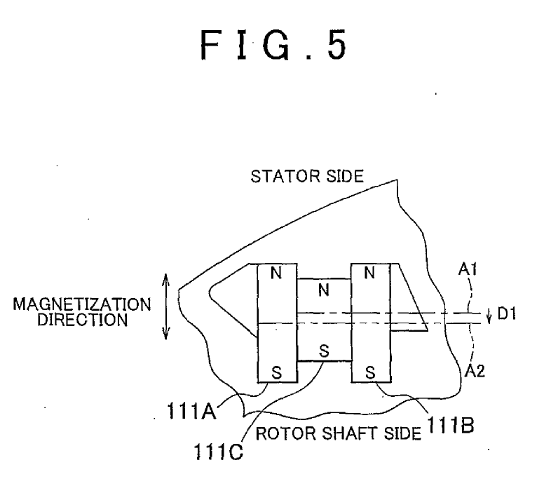

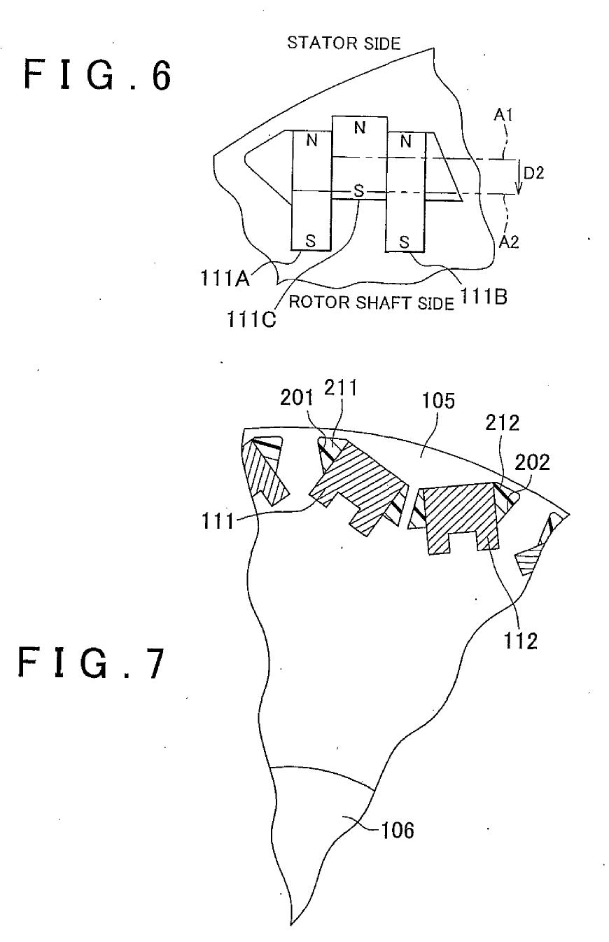

FIG. 5 is a diagram showing a first modification of the magnet configuration shown in FIG. 2. FIG. 6 is a diagram showing a second modification of the magnet configuration shown in FIG. 2.

In the example shown in FIG. 2, the magnet pieces 111A, 111B, 111C form a stepless flat surface on the stator side. In contrast, in the example shown in FIG. 5, the magnet piece 111C is recessed (receded) from the magnet pieces 111A, 111B in the stator-side surface, too. However, the amount of recess on the stator-side surface is smaller than the amount of recess on the rotor shaft-side surface.

In the example shown in FIG. 6, the magnet piece 111C is slightly protruded from the magnet pieces 111A, 111B on the stator-side surface. If the holes of the rotor core have a hole configuration as shown in FIG. 6, the position of the magnet piece 111C is determined even in the case where the magnet piece 111C is firstly inserted. Thus, it becomes possible to change the assembly procedure, and the degree of freedom in the rotor assembly increases.

In the cases shown in FIGS. 5 and 6, each of the first to third magnet pieces 111A to 111C is rectangular in a cross-section orthogonal to the rotating shaft 106. The first and second magnet pieces 111A, 111B are arranged so that a center position A2 of the first and second magnet pieces 111A, 111B along the magnetization direction is more remote from the stator than a center position A1 of the third magnet piece 111C along the magnetization direction is from the stator. The distance by which the center position A2 is more remote is a distance D1 in the case of FIG. 5, and is a distance D2 that is slightly greater than the distance D1, in the case of FIG. 6. In other words, the center position A1 is a center line that symmetrically divide the N-pole end and the S-pole end of the magnet piece 111C. Likewise, the center position A2 is, in other words, a center line that symmetrically divides the N-pole end and the S-pole end of each of the magnet pieces 111A, 111B.

If, in FIG. 5, the center position A2 is brought closer to the stator than the center position A1 is to the stator, the amount of protrusion of the magnet pieces 111A, 111B toward the stator side in the sectional configuration of each magnet in the V-shape arrangement increases. If the amount of protrusion excessively increases, the thickness of a rotor core outer periphery-side wall portion of the magnet insertion hole becomes excessively thin, and the strength of portions of the rotor core that support the magnets against the centrifugal force declines. Furthermore, the magnet pieces 111A, 111B becomes excessively close to the stator, so that the demagnetization of the portions of the magnet pieces adjacent to the stator becomes conspicuous.

Conversely, it is also conceivable to shift the magnet piece 111C to the rotor shaft side in a state where a certain thickness of the rotor core outer periphery-side wall portion of each magnet insertion hole has been secured. However, this leads to a decline in the motor torque. That is, since the distance between the middle portion and the stator becomes longer, the torque that can be produced decreases.

Therefore, as shown in FIG. 5, the first and second magnet pieces 111A, 111B are arranged so that the center position A2 of the first and second magnet pieces 111A, 111B along the magnetization direction is more remote from the stator than the center position A1 of the third magnet piece 111C along the magnetization direction is from the stator.

The adoption of magnets having a configuration as described above and the formation of each of the magnet from three divisions can realize a rotor for a rotary electric machine which prevents the demagnetization while cost increase is restrained as much as possible.

FIG. 7 shows an example in which each magnet is not divided but has an integral configuration in a cross section as shown in FIG. 2.

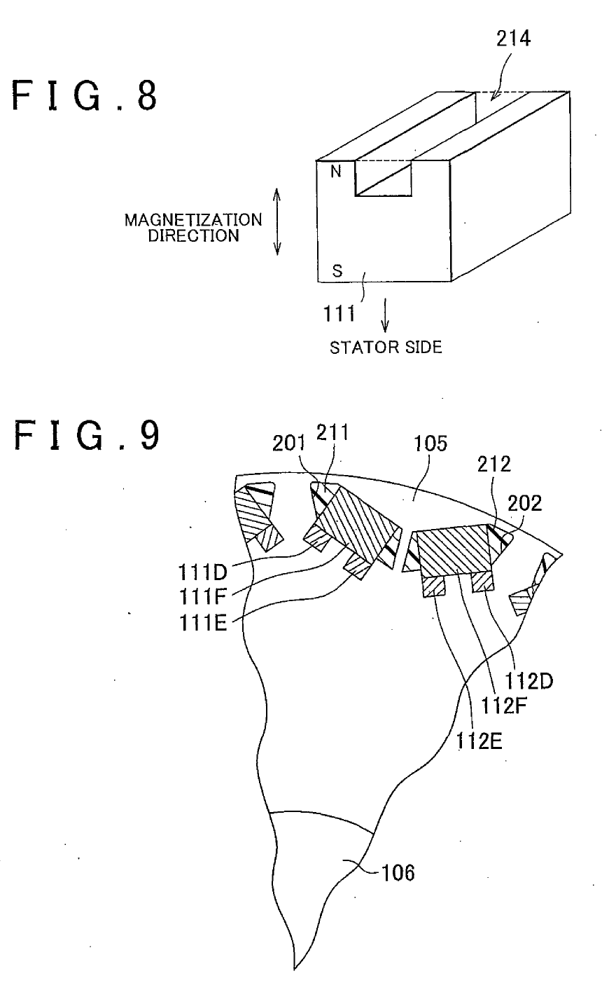

FIG. 8 is a perspective view illustrating a magnet configuration shown in FIG. 7. As shown in FIGS. 7 and 8, an external shape of the magnet may be rectangular with a surface (a surface opposite from the stator side) having a recess portion. Magnets are often made by sintering. It is difficult to make from a sintering material a complicated configuration due to the shrinkage that occurs at the time of sintering. In the case where a sintering material is adopted for the magnet, the magnet having the foregoing configuration can be realized by forming a groove 214 through the machining or cutting of the rectangular magnet. In this example, although the material yield of the magnets is lower than in the example shown in FIG. 2, substantially the same resistance improvement regarding the demagnetization can be expected.

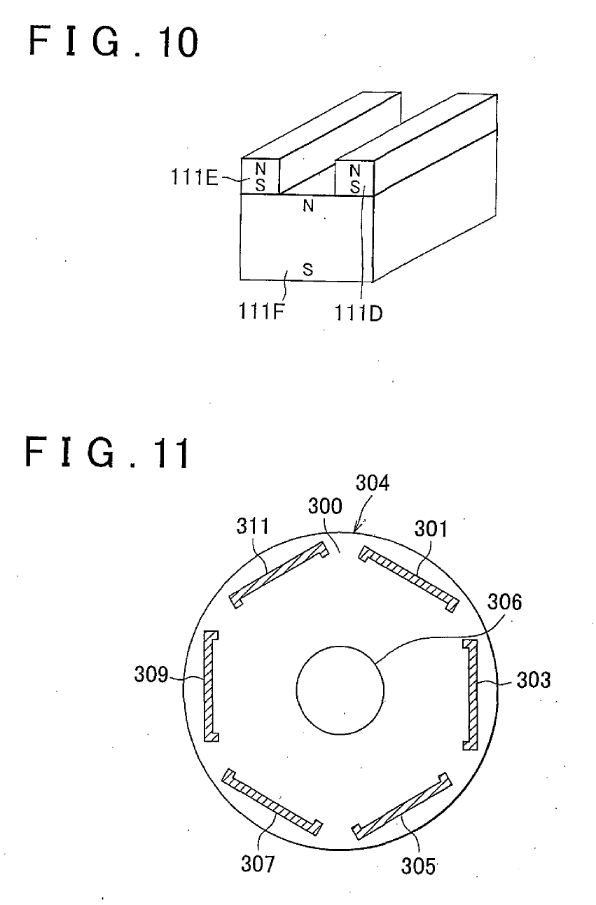

FIG. 9 shows an example in which a magnet is divided in a modified method, in a cross section as shown in FIG. 2. FIG. 10 is a perspective view illustrating a magnet configuration shown in FIG. 9.

As shown in FIGS. 9 and 10, a configuration substantially the same as that shown in FIGS. 2 and 7 may be realized by adding magnet pieces 111E, 111D whose cross-section is small and rectangular to a magnet piece 111F whose cross-section is large and rectangular so that the magnet pieces 111E, 111D form protruded portions. Since the interfaces between the magnet pieces 111E, 111D and the magnet piece 111F exist on the circuit of magnetic flux, there is a possibility of the magnetic flux becoming weaker than in the case shown in FIG. 2. With regard to the demagnetization, however, substantially the same resistance improvement as in the case of FIG. 2 can be expected.

Although in the foregoing embodiments, a pair of magnets in the V-shape arrangement is arranged for each of the magnetic poles of the rotor, the invention is not limited to the V-shape arrangement, but is also applicable to rotors with other arrangements of magnets.

FIG. 11 shows an example of the magnet arrangement that is not a V-shape arrangement. Referring to FIG. 11, a rotor 304 is a six-pole rotor in which permanent magnets 301, 303, 305, 307, 309, 311 are inserted in a rotor core 300. The magnet 301 is thicker in the magnetization direction at two opposite end portions. Likewise, the other magnets 303, 305, 307, 309, 311 are also thicker in the magnetization direction at two opposite end portions.

That is, the rotor 304 is a rotor of a rotary electric machine that is provided around a rotation shaft 306 of a rotary electric machine, and includes the rotor core 300 and the permanent magnets 301, 303, 305, 307, 309, 311 embedded in the rotor core. The permanent magnet 301 includes a first surface that is a flat surface that faces the stator side, and a second surface that is a surface opposite from the first surface. Although not shown, the magnetization direction of each magnet is a direction from the first surface to the second surface, or the opposite direction. The second surface has, in a cross-section thereof orthogonal to the rotating shaft 306, that is, a cross-section shown in FIG. 11, a configuration in which the thickness of the permanent magnet in the magnetization direction of the permanent magnet (the direction from the N-pole toward the S-pole) is greater at two opposite ends thereof in the direction orthogonal to the magnetization direction than at a middle portion between the two opposite ends.

The cross-section of the permanent magnet orthogonal to the rotating shaft 306 is generally rectangular. Of the four sides of the rectangle, a side that is contained in the second surface has, in a middle portion thereof, a recess.

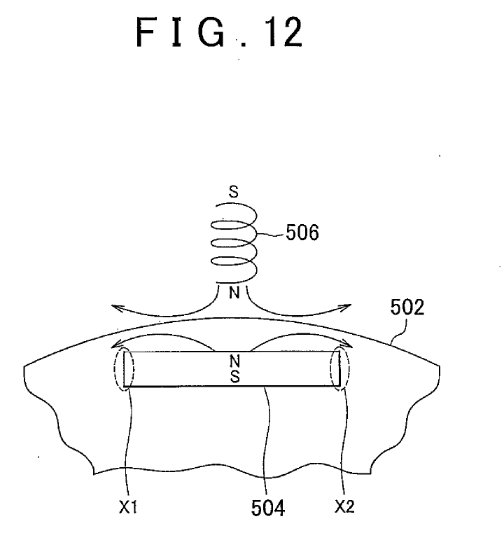

The adoption of such a magnet configuration can reduce the demagnetization of the two opposite end portions as described above with reference to FIG. 12.

The embodiments disclosed herein should be considered to be illustrative in all respects and not restrictive. The scope of the invention is shown not by the foregoing description but by the claims for patent, and is intended to cover all modifications within the meaning and scope equivalent to the claims for patent.

1.-10. (canceled)

11. A rotor for a rotary electric machine that turns about a rotation axis of the rotary electric machine, comprising:
a rotor core; and
a permanent magnet embedded in the rotor core, wherein:
the permanent magnet includes a first surface facing a side of a stator of the rotary electric machine, and a second surface opposite from the first surface;
a center position of a middle portion of the permanent magnet, in a magnetization direction of the permanent magnet is closer to the stator than a center position in the magnetization direction of two opposite end portions of the permanent magnet which are arranged in a direction orthogonal to the magnetization direction is to the stator;
a thickness of the permanent magnet in the magnetization direction is greater at the two opposite end portions in the direction orthogonal to the magnetization direction than at the middle portion;
the rotor comprises a plurality of pairs of said permanent magnets; and
the permanent magnets of each pair are arranged so that same poles are on the same side.

12. The rotor according to claim 11, wherein:
a section of the permanent magnet orthogonal to the rotation axis is generally a rectangle in shape; and
the second surface has, in a middle portion thereof, a recess portion.

13. The rotor according to claim 11, wherein:
in a section of the permanent magnet orthogonal to the rotation axis, the permanent magnet has a first magnet piece and a second magnet piece that are arranged so that the magnetization direction of the first magnet piece and the magnetization direction of the second magnet piece align and so that the first and second magnet pieces are juxtaposed in a direction orthogonal to the magnetization direction, and a third magnet piece that is arranged so that the third magnet piece is positioned between the first and second magnet pieces and so that the magnetization direction of the third magnet piece aligns with the magnetization direction of the first and second magnet pieces; and
a thickness of each of the first and second magnet pieces in the magnetization direction is greater than a thickness of the third magnet piece in the magnetization direction.

14. The rotor according to claim 13, wherein each of the first to third magnet pieces is rectangular in the section.

15. The rotor according to claim 11, wherein:
the stator is arranged radially outward of the rotor;
the rotor further comprises a plurality of permanent magnets that have the same configuration as the permanent magnet;
the plurality of permanent magnets are divided into a plurality of pairs; and
the permanent magnets of each pair are arranged in a V-shape so that each of adjacent portions of the paired permanent magnet is positioned closer to the rotation axis than two end portions of the paired permanent magnet.

16. The rotor according to claim 11, wherein the first surface has, in a section orthogonal to the rotation axis, a configuration in which a middle portion of the first surface is protruded to the side of the stator from two end portions of the first surface which are located in the direction orthogonal to the magnetization direction of the permanent magnet.

17. The rotor according to claim 11, wherein the first surface is a flat surface.

18. A production method for a rotor for a rotary electric machine, comprising:
inserting a first magnet piece whose sectional shape is generally rectangular into each of a plurality of holes formed in a rotor core;
inserting, into the each of the plurality of holes, a second magnet piece whose sectional shape is generally rectangular to a position apart from the first magnet piece which is in each of the plurality of holes; and
inserting a third magnet piece whose sectional shape is generally rectangular between the first and second magnet pieces in each of the plurality of holes.

19. The production method according to claim 18, further comprising pouring a resin for fixing the first to third magnet pieces into each of the plurality of holes.

20. The production method according to claim 18, wherein:
the first to third magnet pieces are arranged so that magnetization directions of the first to third magnet pieces align and so that the first to third magnet pieces are juxtaposed in a direction orthogonal to the magnetization direction; and
the first and second magnet pieces are arranged so that a center position of the first and second magnet pieces in the magnetization direction is more remote from a stator arranged radially outward of the rotor than a center position of the third magnet piece in the magnetization direction is from the stator.
